(19) United States
(12) Patent Application Publication
(10) Pub. No.: US 2015/0124259 A1
(43) Pub. Date: May 7, 2015

(54) Method For Biodynamic Spectroscope Imaging

(71) Applicant: Purdue Research Foundation, West Lafayette, IN (US)

(72) Inventors: Ran An, West Lafayette, IN (US); David D. Nolte, Lafayette, IN (US); John J. Turek, West Lafayette, IN (US)

(21) Appl. No.: 14/526,247

(22) Filed: Oct. 28, 2014

Related U.S. Application Data
(60) Provisional application No. 61/896,603, filed on Oct. 28, 2013.

(51) Int. Cl. G01B 9/021; G01B 9/02

(52) U.S. Cl. CPC G01B 9/021; G01B 9/02043; G01B 9/02091
USPC 356/456

(57) ABSTRACT

Systems and methods for imaging small (˜1 mm thick) living biological specimen is provided to enable the generation of functional 3D images of living tissue for evaluating the effect of an external perturbation on the health of the specimen. A fluctuation power spectrum is constructed for each pixel of a holographic 3D image of the specimen over time and subject to the external perturbation. A normalized spectrum of dynamic intensity as a function of frequency is generated for each pixel. The normalized spectra for each pixel is filtered according to a selected frequency range from among characteristic frequencies corresponding to dynamic activity of naturally occurring biological events within the specimen to provide data corresponding only to the dynamic activity associated with the selected frequency range.

### REFERENCE TO RELATED APPLICATION AND PRIORITY CLAIM

This application is a non-provisional filing from co-pending provisional application No. 61/896,603, filed on Oct. 28, 2013, the entire disclosure of which is incorporated herein by reference.

### STATEMENT OF GOVERNMENT SUPPORT

This invention was made with government support under Grant Number CBET0756005 awarded by the National Science Foundation. The government has certain rights in the invention.

### FIELD OF THE DISCLOSURE

The present disclosure relates to imaging of small living biological specimens and to extracting functional and dynamic information concerning the health of the specimens.

### BACKGROUND

### Tissue Dynamics Spectroscopy (TDS)

Tissue dynamics spectroscopic imaging is a method that operates on data obtained from holographic optical coherence tomography (OCT). The holographic capture of depth-resolved images from optically thick living tissues has evolved through several stages. Optical coherence imaging (OCI) uses coherence gated holography to optically section tissue up to 1 mm deep [1, 2]. (It is noted that the bracketed numbers refer to references in the list of references in the Appendix to this disclosure.) OCI is a full-frame imaging approach, closely related to en face optical coherence tomography [3, 4], but with deeper penetration and high-contrast speckle because of the simultaneous illumination of a broad area [5]. The first implementations of OCI used dynamic holographic media [6] such as photorefractive quantum wells [7] to capture the coherent backscatter and separate it from the high diffuse background. Digital holography [8-11] approaches replaced the dynamic media and have become the mainstay of current implementations of OCI [12]. Highly dynamic speckle was observed in OCI of living tissues caused by dynamic light scattering from the intracellular motions [13]. The dynamic speckle was used directly as an endogenous imaging contrast in motility contrast imaging (MCI) that could track the effects of antimitotic drugs on tissue health [14]. MCI captures the overall motion inside tissue, but is limited to imaging contrast.

The OCI data includes dynamic speckle that is localized from a specified depth within the biological specimen up to 1 mm deep. [15-18]. Previously OCI techniques provide a method for converting the dynamic speckle into time-frequency spectrograms that can be interpreted in terms of biological function[16] and that can be applied to phenotypic profiling of drug candidates [15].

An apparatus for holographic OCT is shown in FIG. 1, which can be the system described in co-pending U.S. application Ser. No. 12/874,855, published on Dec. 30, 2010, as Pub. No. 2010/0331672, entitled “Method and Apparatus for Motility Contrast Imaging”, and in co-pending U.S. application Ser. No. 13/704,464, published on Apr. 18, 2013, as Pub. No. 2013/0088568, entitled “Digital Holographic method of Measuring Cellular Activity and of Using Results to Screen Compounds”. The disclosures of both applications are incorporated herein by reference in their entirety. A suitable apparatus is also disclosed in references [15, 19, 20], the entirety of which is incorporated herein by reference. In the holographic OCT apparatus, two light paths are provided for the optical coherence imaging. Light transmitted through the top-most polarizing beam splitter PBS 1 is the object path illuminating the target, and light reflected by PBS 1 is the reference path. Lenses L3 and L4 expand the reference beam, and lens L5 performs the Fourier transform of the back scattered dynamic speckle reflected back from the target or object beam. The wave plates and the PBS ensure most of the laser power is in the object beam, and most of the back scattered signal reaches the CCD camera. The target is often a multicellular tumor spheroid, but can be any living biological specimen that is sufficiently immobilized.

In TDS experiments, the images are captured at a fixed-depth (usually the mid-plane of the biological specimen, such as a tumor spheroid). For example, if the tumor spheroid has a diameter of 500 microns, the images captured by the CCD camera are the Fourier Domain back-scattered dynamic speckle holograms at the fixed depth of 250 microns in the tumor spheroid. In the experiments, for each 4 min interval (a data set) 2 acquisition rates are applied. First 200 images are captured at 10 fps; then another 100 images are captured at 0.5 fps. Thus after combining the high frequency data and the low frequency data, in each 4 min interval, the spectrum frequency range is from 0.005 Hz to 5 Hz across 3 orders of magnitude.

In every experiment, there are always a baseline at which no stimuli is added. In one example, the tumor spheroid is held at 37 degrees centigrade and covered by growth medium. After the baseline, different perturbations may be added, after which data are collected for six hours or longer, subject to the maintenance of specimen health over that time.

Dynamic Speckle

The raw hologram captured on the digital camera has interference fringes that are generated by the off-axis reference wave. These represent a spatial carrier wave that modulates the Fourier-domain signal. The raw hologram is Fourier transformed back into the image domain, including image-domain speckle. The data are acquired as a succession of frames, from which the speckle intensity is reconstructed as a time series for each pixel, as shown in FIG. 2a. The fluctuating signal is Fourier transformed in time into a power spectrum, for example as shown in FIG. 2b.

Differential Spectrograms

For each data set, the power spectrum of the data is calculated through:

$$\begin{matrix}Φ ( z ; x , y ; ω , t ) = {\vert \frac{1}{\sqrt{2 π}} {\int }_{- ∞}^{∞} f ( z ; x , y ; τ , t ) {e}^{- i ω π} d τ \vert}^{2} \\ = \frac{F ( z ; x , y ; ω , t ) {F}^{*} ( z ; x , y ; ω , t )}{2 π}\end{matrix}$$

Each voxel (z: x, y) (where x,y represents each pixel) has one power spectrum. The power spectrum of each voxel is averaged over the selected area of the tumor spheroid. Due to the biological differences between the shell area and core area, the shell and core power spectra are averaged separately over these large collections of pixels:

$${S}_{i} ( ω , t ) = \frac{{\sum }_{x , y ∈ i} Φ ( z ; x , y ; ω , t )}{{〈 {\sum }_{x , y ∈ i} Φ ( z ; x , y ; ω , t ) 〉}_{ω}}$$

where the subscript i indicates the shell or the core area of the tumor spheroid.

To generate a response spectrogram, the spectrum of each data set is normalized by the baseline. The relative differential change in the power density, which is used for tissue dynamics spectroscopy [16, 21] is:

$$D ( ω , t ) = \frac{S ( ω , t ) - {S}_{0} ( ω )}{{S}_{0} ( ω )} .$$

By combining D(ω,tᵢ), i=1 . . . n from all the data sets (the subscript i indicates the multiple time points), the spectrogram is generated, such as the drug response spectrogram shown in FIG. 3 for Iodoacetate and Cytochalasin D [22]. The horizontal axis is time, and the vertical axis is frequency from 0.005 Hz to 5 Hz. The spectrograms show the relative changes in the frequency content of the tumor spheroid as a function of time, which is an indication of the state or health of the spheroid.

Mechanisms and Interpretations

The biological mechanisms underlying the tissue-response spectrograms can be understood in terms of backscatter frequency and characteristic motions of the different intracellular constituents. Dynamic light scattering has been performed on many biological systems. The backscattering frequencies are well within the range of intracellular motion in which molecular motors move organelles at speeds of microns per second [23-27). Diffusion of very small organelles, as well as molecular diffusion, are too fast to be resolved by a conventional maximum frame rate of 10 fps. Membrane undulations are a common feature of cellular motions, leading to the phenomenon of flicker [28-32]. The characteristic frequency for membrane undulations tends to be in the range around 0.01 to 0.1 Hz [26, 29, 33]. Some of these features of cell motion are summarized in graph of FIG. 4 which shows the effective diffusion coefficient as a function of constituent size. It can be seen from this graph that there is a general trend that small objects move faster, and larger objects move slower. Therefore, high-frequency signals relate to organelles and vesicles and their active transport, while low-frequency signals relate to cell membranes and cell shape changes.

The microscopic and mechanistic interpretation of backscatter frequencies that is part of prior techniques points to a size-frequency trend. However, no system has been found that can utilize the size-frequency trend to provide information regarding the health of living biological tissue.

### SUMMARY

A system and method is provided for evaluating mitotic activity or tumor heterogeneity in a living biological specimen as a means for evaluating tissue health, particularly when subject to external perturbations. The method utilizes optical coherence imaging to generate holographic images of a specimen at specific depths and the application of motility contrast imaging to capture overall motion inside the tissue in the form of time-frequency spectrograms. According to the present disclosure, biodynamic spectroscopic imaging (BSI) uses time-frequency tags applied to microspectrograms across all pixels of the holographic image according to size-frequency trends for the biological specimen.

In one aspect, a microspectrogram is generated for each voxel and a single-band threshold is applied to the spectrogram aligned at a frequency range corresponding to mitotic activity. In another aspect, a dual frequency gate is applied to the same spectrogram to identify spectral response fingerprints of a drug applied as a perturbation and to distinguish this spectral response from the spectral response fingerprint of mitosis.

In a further aspect of the biodynamic spectroscopic imaging disclosed herein, the application of the single band (or dual frequency band) threshold values yields a BSI image that identifies only voxels containing mitotic activity, or more particularly identifies voxels corresponding to the particular cells in the holographic image. With only the mitotically active voxels highlighted, the effect of an external perturbation on the health of the biological specimen can be readily evaluated over time, either by viewing filtered BSI images generated over time intervals, or by directly plotting quantification of the mitotic activity in relation to the entire size of the specimen or tumor.

In another feature, biodynamic spectroscopic imaging can be used to assess homogeneity of the live biological specimen or tumor. In particular, the BSI process can determine spatial variation from pixel to pixel of the response of the local groups of cells within the pixel to an applied drug or an altered environmental condition. In one aspect, a time-frequency mask is applied to a microspectrogram, in which the mask is calibrated to extract specific feature vectors. Multiple masks may be used to create multiple feature vectors that are then used to classify a drug response.

### DESCRIPTION OF THE FIGURES

FIG. 1 is diagram of a system for performing holographic optical coherence tomography.

FIGS. 2a, b are graphs of single pixel intensity and a Fourier power spectrum of the fluctuating pixel intensity of a raw hologram obtained with the system of FIG. 1.

FIGS. 3a, b are spectrograms of proliferating tissue in a tumor spheroid subject to chemical treatments showing relative changes in frequency content of the tumor spheroid over time.

FIG. 4 is a diagram of the connection between light-scattering diffusion and components of a living biological specimen.

FIGS. 5a, b are graphs of the spectral power density of a single pixel and an average SPD over the shell area of a tumor spheroid.

FIG. 6 shows microspectrograms of single voxels of a tumor spheroid at a fixed depth showing a voxel in the shell area and a voxel in the core area, generated according to the present disclosure.

FIG. 7 is a microspectrogram of a single voxel in a tumor spheroid illustrating single-band thresholding according to the present disclosure.

FIG. 8 is a microspectrogram of a single voxel in a tumor spheroid illustrating dual frequency, double time thresholding according to the present disclosure.

FIG. 9a, b, c are macro-spectrograms for the shell and core of a tumor spheroid in normal growth medium, in a medium containing 1 μg/ml Paclitaxel and in a medium containing 10 μg/ml Paclitaxel showing the change in frequency content over time.

FIG. 10 are biodynamic spectroscopic images obtained according to the present disclosure of a proliferating tumor spheroid and a tumor treated with Taxol.

FIG. 11 is a graph of mitotic fraction of voxels for two proliferating tumors and two tumors treated with Taxol at doses of 1 μg/ml and 10 μg/ml.

FIG. 12 is a graph of spheroid growth delay obtained using conventional approaches.

FIG. 13 are macro-spectrograms of the shell and core of a tumor spheroid pursuant to a serum starvation experiment, using the biodynamic spectroscopic imaging system and procedures disclosed herein.

FIG. 14 is a graph of the number of mitosis events vs. time for a given tumor subject to serum starvation.

FIG. 15 are examples of a time frequency mask and a threshold function according to one aspect of the present disclosure.

FIG. 16a is a motility contrast image of a tumor spheroid.

FIG. 16b are spectrograms obtained by tissue dynamics spectroscopy of the tumor spheroid shown in FIG. 16a.

FIG. 16c is a tissue dynamic image generated from the spectrograms of FIG. 16b for the tumor spheroid shown in FIG. 16a according to the present disclosure.

FIG. 17 is a classification map generated from the image shown in FIG. 16c according to one aspect of the present disclosure.

FIG. 18 includes spectrograms and a tissue dynamic image obtained by tissue dynamics spectroscopy of another tumor spheroid in accordance with the methods disclosed herein.

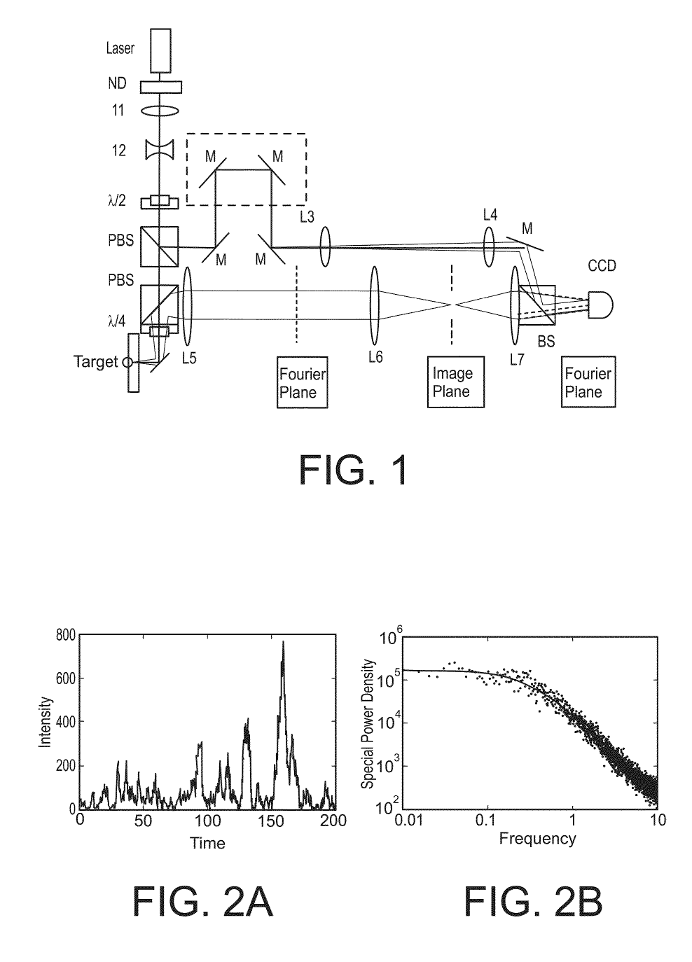

### DETAILED DESCRIPTION

According to the present disclosure, a new technique is provided for constructing a new type of spectrogram tag that extracts the location where mitosis is occurring inside living tissue. As described below, the size-frequency trend illustrated in FIG. 4 guides the definition of alternative spectrogram filters that enable the functional imaging of heterogeneous tumors or other types of tissues.

Methods for Biodynamic Spectroscopic Imaging (BSI)

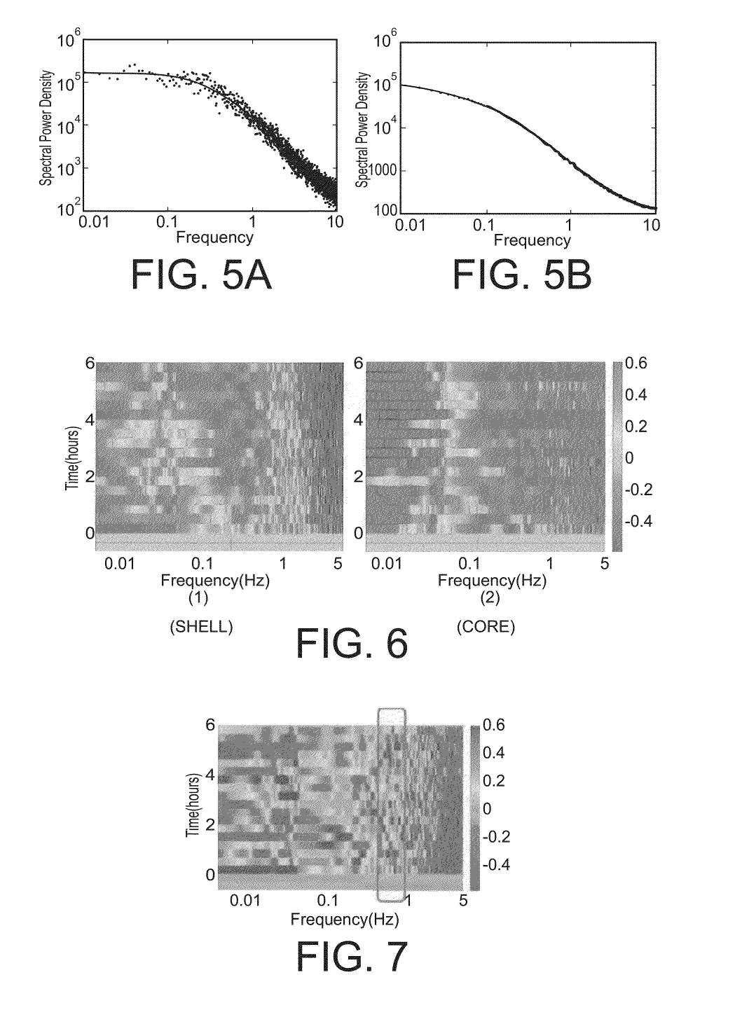

In the TDS mode described above, the power spectrum is averaged over a large area of the tissue, thus the noise of the spectra were significantly reduced and the spectra are generally smooth, as shown in FIG. 5b. For tumor spheroids, the biological properties of the shell area of the spheroids are very different from the core area. Therefore, in TDS the shell and core values are averaged separately. However, because of the high heterogeneity of living tissue, averaging on shell and core scale causes a loss of significant spectral information content, especially localized cellular spectral responses. For example, in the cell cycle, mitosis is the most dramatic process, especially in telophase and cytokinesis. Within mitosis (and cytokinesis), the cell membrane, shape and cell organelle all have enhanced motility. Though mitosis has very strong and unique spectral fingerprints, for an entire tumor spheroid a single cell mitosis is a statistically low probability event. Therefore, these fingerprints easily can be buried by tissue-averaged spectrograms generated by TDS.

In order to observe the localized cellular motility changes, the present disclosure contemplates a new technique in which analyzing pixel-based spectra replaces the statistical TDS method described above. According to the present disclosure, biodynamic spectroscopic imaging (BSI) provides unbiased localized information and expresses heterogeneities via multispectral imaging. In BSI, each independent localization area is called a voxel. The voxel size varies depending on different application topics.

One of the most significant challenges of BSI is the balance between the level of localization and the level of noise reduction. A single-pixel spectrum has the best localization resolution, while the pixel spectrum in FIG. 5a shows that the noise of the single pixel spectrum is too large. In the high frequency range, the fluctuations are almost an order of magnitude larger than the average signal. On the other hand, averaging more pixels provides better signal-to-noise (S/N) ratio, however single-cell motility may be averaged out. The balance between these two parameters depends on many factors—the resolution needed, the size of the living tissue sample, the kinds of biological events of interest, the limit of the optical components and the limits of the CCD camera—and the balance of these factors varies case by case. For example, to study the relation between the process of tissue apoptosis and drug diffusion into living tissue, the localization resolution is not very critical and the signal-to-noise ratio is more important. Therefore, the averaging region can be picked as rings centered at the spheroid center with a ring width of 3 pixels. As a second example, to study mitosis the localization resolution is very important because mitosis is an event of a single cell. For a single cell the mitosis process provides dramatic cellular property changes, so the spectral signal is strong. In this case, the averaging region can be picked as 2×2 pixels.

An estimate can be made of the level of localization required to measure a certain signal arising from intracellular processes. Consider a spectrum S(ω) that is the average of N pixels (or voxels). For this group of pixels to generate a significant signal the following requirement must be met:

$$Δ S ( ω ) = \frac{σ ( ω )}{\sqrt{NB}}$$

where ΔS(ω) is the smallest detectable signal strength for a process captured by BSI, B is the integrated bandwidth and σ(ω) is the standard deviation of the signal for a single pixel. The smallest detectable signal improves with the number N of pixels that are averaged, but that same averaging over pixels reduces spatial resolution. In addition, the integrated bandwidth B leads to better detection with larger frequency ranges, but reduces the frequency discrimination. Depending on the biological process, N and B can be chosen to provide the best combination of spatial resolution and sensitivity.

Another unique aspect of BSI is the selection of the baseline. In TDS, the baseline is picked as the first several hours when the newly-harvested tissue is only surrounded by growth medium and no perturbation is added. This same TDS baseline was referred to for the study of mitosis in spheroids. [34, 35] However, this selection of the baseline is not the most appropriate for the low signal-to-noise conditions of BSI. Therefore, the condition for performing TDS on individual pixels, as described in prior references [34, 35], is inadequate for BSI. One of the following three different baselines must be chosen to perform BSI depending on which biological process is of interest:

1) When the study focuses on single-cell behavior, like mitosis under normal growth medium, the baseline is the averaged spectrum over the entire tissue at the selected time.

S₀(ω)= [symbol] S(ω,Tᵢ) [symbol] _{all pixels}

Therefore, the general systematic spectral drift (like the macro response) can be subtracted out.

2) When the process of interest involves a system-wide application of a stimulus, as in the application of a drug, then a baseline that is highly stable is:

S₀(ω)= [symbol] S(ω) [symbol] _{all pixels-all T<T}_{₀}

where the average is over all pixels and for all times before the application of the stimulus.

3) When the study focuses on the heterogeneous responses of different tissue parts (e.g. the junction of two connected tumors or other areas of two tumors), the baseline can be the average spectrum of the selected pixel(s) when it is exposed only to growth medium:

S₀(ω)= [symbol] S_{single pixel}(ω) [symbol] _{all T<T}_{₀}

It can be noted that this third case baseline is akin to performing pixel-based TDS. [34, 35]. Because the third baseline is the spectrum of only a single pixel, it may have a very high noise level and may not be stable. Therefore, in this third case, it may be necessary to create a smoothed spectrum to replace the experimental average. The spectrum may be smoothed numerically using any known numerical technique. In addition, it is possible to fit a smooth function to the noise baseline spectrum. In particular, a special smooth function is provided that captures the character of tissue spectra:

$$S ( ω ) = FT ( {A}_{l} ( τ ) ) = \frac{{V}_{l}}{π} {\sum }_{n} [ \frac{4}{( 3 - {β}_{n} )} \frac{{f}_{n} {ω}_{n}^{{β}_{n}}}{( {ω}_{n}^{1 + {β}_{n}} + {ω}^{1 + {β}_{n}} )} ]$$

where βₙ is an anomalous diffusion exponent that is usually in the range βₙ=0.7-1.3. This equation retains the summation over the different dynamic processes taking place inside living tissue, in which each process has a characteristic frequency ωₙ. Because most motions in living cells are stochastic, even if they are actively driven by molecular motors consuming ATP, the motions are best described in terms of an effective (active) diffusion coefficient Dₙ. The characteristic frequencies are ωₙ=q²Dₙ. The effective coefficients Dₙ describe different types of motion, such as vesicle or nucleus motion, and may be affected differently depending on the drug. When a perturbation or drug is applied, the differential response is:

$$\frac{d S ( ω )}{d {ω}_{n}} = \frac{{V}_{l}}{π} {\sum }_{n} \frac{4}{( 3 - {β}_{n} )} {f}_{n} {β}_{n} {ω}_{n}^{{β}_{n} - 1} [ \frac{{ω}^{1 + {β}_{n}} - {ω}_{n}^{1 + {β}_{n}}}{{( {ω}^{1 + {β}_{n}} - {ω}_{n}^{1 + {β}_{n}} )}^{2}} ]$$

The differential relative spectral power density is defined as before as:

$$D ( ω , t ) = \frac{S ( ω , t ) - S ( ω , {t}_{0} )}{S ( ω , {t}_{0} )}$$

where S(ω,t) is the power spectrum at time t, and tₒ is the time used for normalization (prior to perturbation of the tissue). Then for a single knee frequency:

$$D ( ω ) = \frac{Δ {ω}_{n}}{{ω}_{n}} [ \frac{{ω}^{1 + {β}_{n}} - {ω}_{n}^{1 + {β}_{n}}}{{ω}^{1 + {β}_{n}} + {ω}_{n}^{1 + {β}_{n}}} ]$$

But for multiple knee frequencies:

$$\text{?} \frac{\text{?}}{\text{?}}$$

$$\text{?} \text{indicates text missing or illegible when filed}$$

After picking the needed kind of baseline, a microspectrogram can be generated for each voxel. It is understood that a microspectrogram corresponds to a spectrogram for a smaller area of the specimen, as opposed to a macrospectrogram which is essentially generated over the entire specimen or tumor spheroid. There are two approaches to generating spectrograms. In the first approach, the mathematical process is similar to the macrospectrogram generated using TDS. FIG. 6 shows an example of such a microspectrogram when the voxel size is 2×2 pixels for N=4. In the second approach the differential relative spectrogram is replaced by a logarithmically differenced spectrogram. This eliminates the division, or normalization, by a possibly noisy spectrum. The log spectrogram is obtained as:

L(ω,T)=log S(ω,T)−log S₀(ω)

where S(ω) is the baseline chosen from one of the three methods. This L(ω,T) is best for the third type of baseline that uses only a single pixel.

Assessing Mitotic Fraction

Microspectrogram and Thresholding

The mitosis phase has its own fingerprint because mitosis is one of the most dramatic events in a cell's life. However compared to the dynamic speckle from an entire tumor spheroid, the signal of the mitosis of a single cell is very weak. The statistical TDS technique is not able to show the mitosis events of single cells. On the other hand, BSI may be applied to generate a voxel based microspectrograms. In the current TDS system, the transverse and longitudinal resolution are 9 μm and 18 μm, and the typical size of UMR106 cell in tumor spheroid is about 10 um. Therefore, on the reconstructed image, each pixel contains about 4 cells. However the spectrum of a single pixel is too noisy to perform analysis, so 2×2 pixels can be preferably used as the balance point to calculate the spectra of the voxels. Thus, according to one aspect of the BSI method disclosed herein, the 3D image is reconstructed as voxels, rather than pixels, in which a voxel includes 2×2 pixels. The microspectrograms are then generated for each voxel, rather than pixel, which substantially eliminates the effect of noise in the image.

One cell cycle for UMR 106 is about one day, and the most active part of mitosis last for about 20-30 mins. Therefore, for a single voxel, the normalized spectra from five datasets (20 mins) can be averaged together, with no risk of “missing” a biological event of the cell. By combining these normalized spectra together, the micro (voxel) spectrograms are generated. The baseline is the averaged spectrum over the entire tissue when it is only surrounded by growth medium. During the entire experimental period, each voxel corresponds to one spectrogram. A frequency vs. time fluctuation spectral response image of the tumor spheroid is constructed.

Single-Band Thresholding

The frequency range is picked at a mid-high frequency band (0.52 Hz to 1 Hz, marked as a box in FIG. 7) and enhancement is picked as the finger print of the mitosis. The enhancement in this frequency range indicates both cell membrane undulation and cell organelle motion during mitosis. It has been found that on a single microspectrogram, if within 20 min (5 datasets) this frequency band average normalized spectral value is larger than 0.15 (threshold) a mitosis event in that voxel is indicated. The prior approach discussed above [34, 35] referred to single-band thresholding that used the third case baseline described above as essentially a pixel-based TDS. This pixel-based TDS approach fails to isolate mitosis from other biological processes and to isolate mitosis from noise. Therefore, single-band thresholding only correctly acquires mitosis information when using the first or second case baselines described above.

Double-Frequency Double-Time (DF-DT) Thresholding

While the single-band thresholding of the prior approaches was presumed to capture the mitotic activity, because of the connection of the higher frequencies to rapid motion, like cytokinesis, this prior single-band thresholding approach failed to differentiate mitosis from other non-mitotic biological drug responses. This is because there are many drugs that can cause an enhancement in the mid-frequency range whose mechanism of action is not related to mitosis. Therefore, it is necessary in BSI of mitosis to use a unique thresholding technique to match the biological function that does not just rely on pixel-based TDS that uses frequency filters, but instead applies the concept of tags. For instance, cytochalasin D has a similar fingerprint to the one used in the single-band thresholding example. Because cytochalasin D disrupts actin filaments, if a single-band thresholding technique is applied, then many of the supposed mitosis events are actually false events due to the drug effect of cytochalasin D. Therefore, the single characteristic frequency band is not robust under cytochalasin D or other drugs which would cause enhancements in a single frequency range.

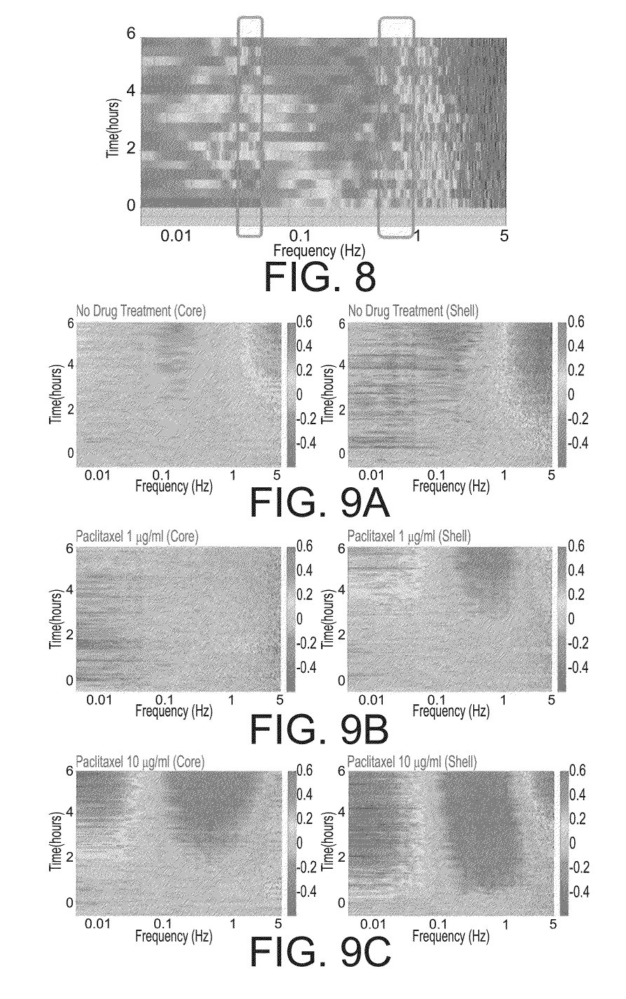

Therefore, from the nature of mitosis and cytokinesis, a double-frequency double-time (DF-DT) tag method for mitosis detection is disclosed herein that is robust and uses the unique data format of the time-frequency spectrograms. The double-gate has two frequency ranges with different thresholds for each, as illustrated in the spectrogram shown in FIG. 8. As the cell passes through cytokinesis, the single cell divides into two cells. The additional cell needs more room than the previous single cell, so after cytokinesis, the shape of the new cells changes slowly. This motion causes a strong low-frequency enhancement. A key element in this double frequency double-time (DF-DT) method is the additional criterion that in a 20-minute period, if there is an enhancement in the higher frequency band (cytokinesis), then the DF-DT mitosis detection method looks for the low frequency band (0.03-0.05 Hz) within the next 20-minutes. If the averaged value of the dynamic spectra is higher than 0.45, which indicates cell shape change and membrane movement after mitosis, the present method marks that pixel as a single mitosis event. Therefore, the double-gate double-time thresholding successfully captures mitosis without, or at least with low, false positives.

Thus, in accordance with one aspect of the present disclosure, the DF-DT gate approach first identifies two frequencies of interest—one associated with the biological activity of interest (e.g., mitosis) and the other associated with a related biological activity (e.g., cytokinesis). According to the method, if the biological activity of interest is detected upon application of the first frequency gate within a given time period, then the second frequency gate is applied to the spectrogram at a subsequent time period to determine if the related biological activity has occurred. If it has, then the particular pixel/voxel is identified as having the biological activity of interest. If not, i.e., if the second frequency gate does not show dynamic activity above a threshold value, then it is determined that the subject pixel/voxel is not having the biological activity of interest.

### Example 1

### Taxol Treatment

Paclitaxel is a mitotic inhibitor used as an anti-cancer drug. It can stabilize microtubules so that cell division during mitosis can be interrupted. Experiments were performed using 2 concentrations of Paclitaxel: 1 μg/ml and 10 μg/ml. The tumor spheroids in these experiments were 430 μm diameter (1 μg/ml) and 410 μm diameter (10 μg/ml). The baselines were taken as described above. The macrospectrograms for the untreated baseline is shown in FIG. 9a. After 40 minutes, the original growth medium was replaced by medium with Paclitaxel. The data was collected for six hours, and the resulting macrospectrograms of the experiments are shown in FIG. 9b for 1 μg/ml and FIG. 9c for 10 μg/ml.

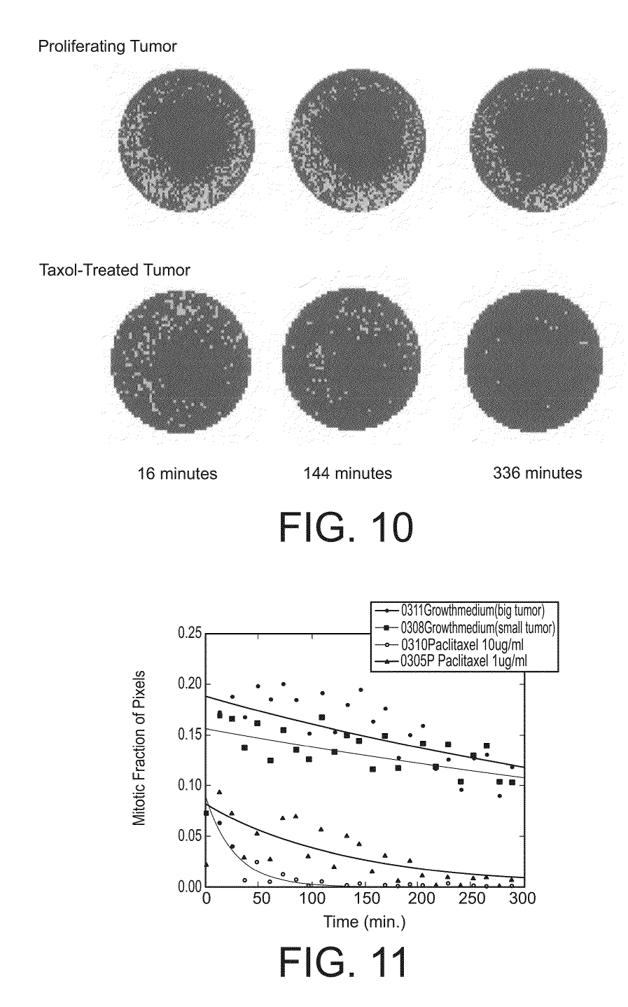

The thresholding used in this example is based on the single-band method using the first case baseline described above that averages the baseline over all pixels for all times. In this demonstration, the single-band threshold was set at the mid-frequency range 0.52-1.0 Hz as the frequency fingerprint of mitosis. The BSI images of the Taxol treated and untreated tumor spheroids filtered at the single gate threshold are shown in FIG. 10. Each light speckle in each image represents a mitosis event. From the images it is clear that when treated by Taxol, the mitosis activity inside the tumor spheroids is significantly reduced. The mitosis events of the untreated tumor spheroids decay very slowly, but are still very prevalent after nearly six hours. The mitosis events depicted in the BSI images of FIG. 10 are quantified in the graph of FIG. 11. The y-axis of the graph is the density of the voxels which are in the mitosis phase expressed as a fraction of the mitotic voxels to the total number of voxels for the underlying image. The x-axis is the time after the perturbation was applied. From the graph the negative controls had the most mitotic events and decayed slowly. On the other hand, the 1 μg/ml Paclitaxel experiment had fewer mitotic events and decayed faster. The 10 m/ml Paclitaxel experiment decayed the fastest and two hours after applying the drug there is almost no mitosis at all. There was still slight mitosis occurring six hours after applying the 1 μg/ml Paclitaxel dose.

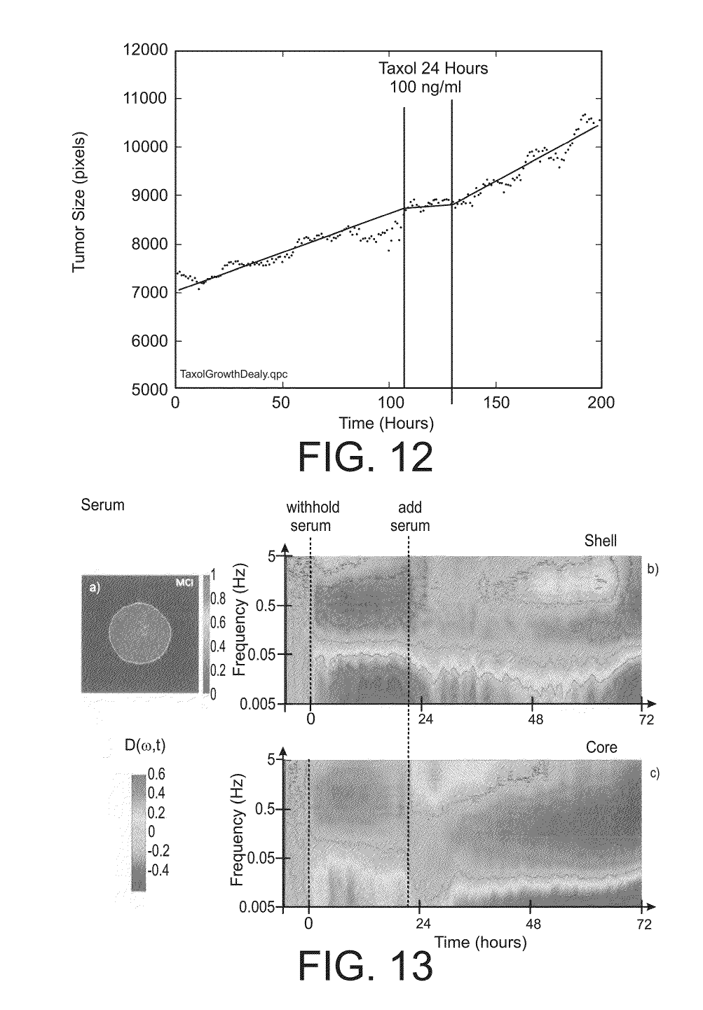

By way of comparison, FIG. 12 shows the conventional approach to determining drug efficacy in which the measurement is of growth delay caused by exposure to the treatment drug. This prior approach measures the size the delay of growth and requires several days (e.g., 200 hours) to complete and interpret. In contrast the BSI technique provides cellular-level mitosis information and graphically demonstrates the delay within hours.

### Example 2

### Serum Starvation for 24 Hours

Serum provides key nutrition and growth factors for mitosis. Using serum starvation to synchronize the cell cycle of the UMR106 cell line is a standard approach. Serum starvation is usually performed as a control experiment when growth-factor related topics are studied. If the tumor spheroid is serum starved, the mitosis decreases significantly and finally stops. The tumor spheroid used in this experiment was 300 microns in diameter. The baseline and the threshold are the same as in Example 1. After the baseline, the original growth medium was removed and fresh growth medium was added. The fresh growth medium was the same growth medium except no serum was added. Data were collected for 24 hours, after which the growth medium without serum was replaced by fresh normal growth medium (with serum). Data were collected for 48 hours. The macrospectrograms of the experiments are shown in FIG. 13, with the upper image showing the shell and the lower image showing the core.

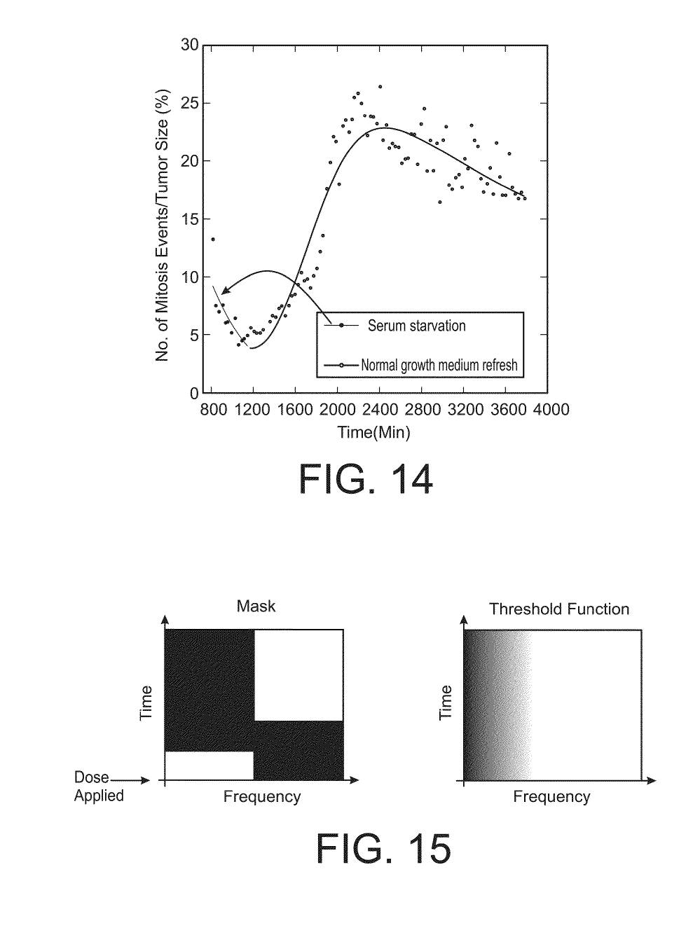

BSI images are generated from the microspectrograms. The number of mitosis events are quantified in the graph of FIG. 14 similar to the graph of FIG. 11, namely identifying the fraction of mitotic event to the entire tumor size. This graph shows that after the serum starvation started, the mitosis gradually decreased. The characteristic time of the decay is about 400 minutes. After one day there was only 5% of the entire tumor spheroid having mitosis events. Because the cells which were at the mitosis phase finish their current cell cycles in one day, other cells could not start new cycles due to serum starvation. After reapplying serum to the growth medium, the number of mitosis events increased because most of the cells are at the beginning of their cell cycles. After half of a day there was a ‘boom’ in the number of mitosis events because of cell cycle synchronization. The mitosis events increased rapidly. About 16 hours after serum refreshment, the number of events reached to a maximum, then slowly relaxed to a normal mitosis rate. The characteristic time of the rapid increase phase is 6700 minutes. The characteristic time of the slowly relaxation is about 4000 minutes.

### Assessing Tumor Heterogeneity

Tumor heterogeneity, as it relates to biodynamic imaging and tissue dynamics spectroscopy, is a spatial variation from pixel to pixel of the response of the local cells within the pixel to an applied drug or an altered environmental condition. One clear application of pixel-based tissue dynamics spectroscopy is the spatial mapping of different functions across the volume of a living tissue sample.

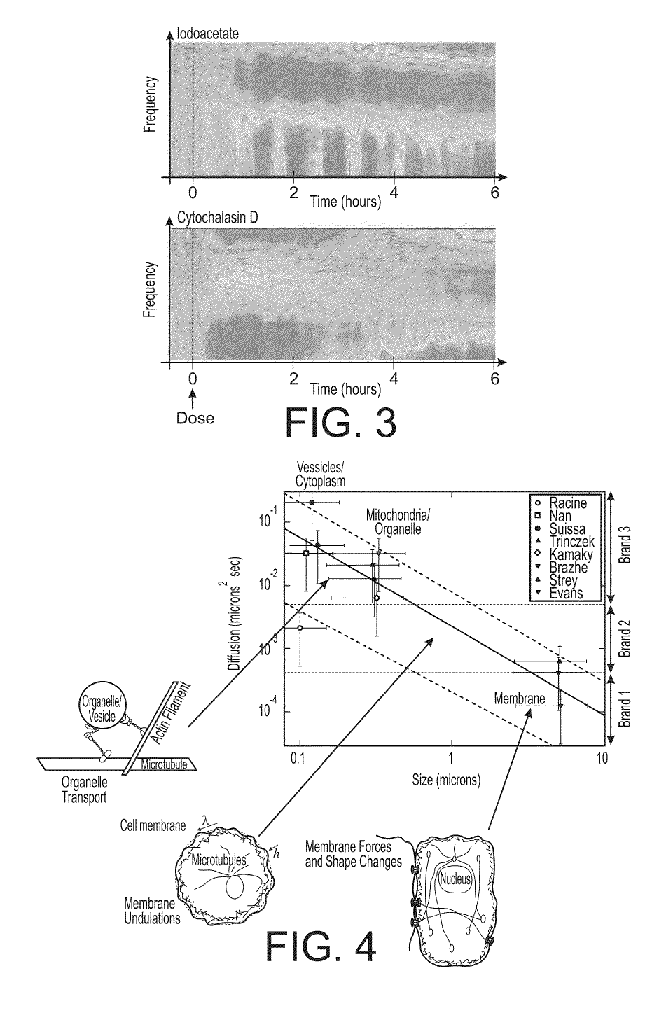

In a previous co-pending application Ser. No. 13/760,827, entitled “System and Method for Determining Modified States of Health of Living Tissue”, filed on Feb. 6, 2013, and published as Pub. No. 2013/0144151 (the '151 application), the entire disclosure of which is incorporated herein by reference, a method is described that uses time-frequency masks to extract feature vectors. Multiple masks are used to create feature vectors that are then used to classify a drug response. In accordance with the present disclosure, the BSI techniques described herein can use the same or similar time-frequency masks to capture different mechanisms related to the drug action, and then perform the analysis on a per-pixel basis to generate “hyperspectral” maps of the tumor response to drugs. Because the signal-to-noise of single-pixel power spectra for biodynamic spectroscopic imaging (BSI) is not as large as for tissue dynamics spectroscopy (TDS) that averages over many pixels, it is necessary to modify the time-frequency mask from that described in the '151 application. The time-frequency spectral power density is given by S(ω,T). This power spectrum typically has a power-law decay at higher frequencies, with several orders of magnitude in vertical dynamic range. In the TDS method, this wide dynamic range is handled by taking a difference and normalizing by the baseline spectrum to create a relative differential spectrogram (as illustrated by the macrospectrograms shown in FIGS. 3, 9, 13). Because of the lower signal-to-noise of single pixels, this former approach does not work to give stable spectrograms in BSI. Therefore, in the BSI method the time-frequency mask for feature “a”, given by the mask Mₐ (ω,T), is applied to the logarithmic difference in the power spectrum as:

$${F}_{a} = {\int }_{0}^{{T}_{max}} {\int }_{{ω}_{min}}^{{ω}_{max}} [ log S ( ω , T ) - log {S}_{0} ( ω ) ] {M}_{a} ( ω , T ) \frac{d ω}{ω} d T$$

where Fₐ is the numerical value of this feature and Sₒ (ω) is the BSI baseline selected in one of the three ways described above. Such masks perform as “gates” that capture selected regions of a spectral response to an applied drug.

It is also useful to perform thresholding on the spectrum in addition to the gate. This is performed as:

$${G}_{a} = {\int }_{0}^{{T}_{max}} {\int }_{{ω}_{min}}^{{ω}_{max}} F [ log S ( ω , T ) - log {S}_{0} ( ω ) - {A}_{a} ( ω , T ) ; σ ] \frac{d ω}{ω} d T$$

where Aₐ(ω,T) is a selected “bias” function of both frequency and time, and F(x,σ) is the Fermi function that varies between zero and unity with slope parameter σ. The threshold function Aₐ(ω,T) selects the regions that are chosen to be non-zero when integrated.

In another embodiment the thresholding is combined with gating as:

$${H}_{a} = {\int }_{0}^{{T}_{max}} {\int }_{{ω}_{min}}^{{ω}_{max}} F [ log S ( ω , T ) - log {S}_{0} ( ω ) - {A}_{a} ( ω , T ) ; σ ] {M}_{a} ( ω , T ) \frac{d ω}{ω} d T$$

to provide the maximum flexibility to select specific features within the spectral response of the living tissue to the applied drug. Examples of a mask function Mₐ (ω,T) and a threshold function Aₐ(ω,T) in the time-frequency space of the spectrograms are shown in FIG. 15. The choice of the selected regions in time and frequency are guided by the biology illustrated in FIG. 4 as well as information about the pharmacodynamics and pharmacokinetics. The mask and threshold functions are guided by specific mechanisms of drug transport and biological mechanisms of action. For instance, different cell lines have different knee frequencies that dictate where the frequency cuts for the mask and threshold functions occur. These knee frequencies are obtained through fluctuation spectroscopy measurements on the different cell-line tumors. Additionally, the time cuts are dictated by biological times, such as cell division times, or cell cycle time, or by the rate at which drugs diffuse into the tumors.

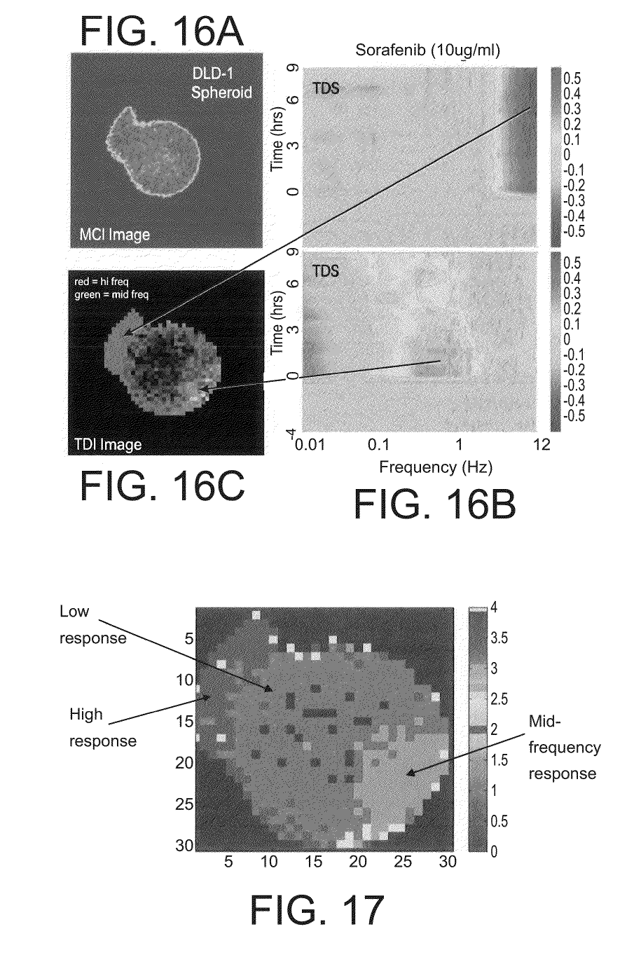

An example of the application of this BSI approach to imaging tumor heterogeneity is shown in FIG. 16. The tumor is a DLD-1 tumor spheroid that is approximately 600 microns in diameter. In FIG. 16a the MCI image of the tumor shows a relatively uniform motility across the sample, with only a slightly lower motility in the center. A Raf kinase inhibitor drug Sorafenib was applied to the spheroid. The masks shown in FIG. 15 were applied to a spectrogram generated from the MCI image, as show in FIG. 16b. One mask produced the high-frequency enhancement in the uppermost spectrogram, and the other mask produced a midfrequency enhancement as shown in the lowermost spectrogram. The results are plotted as pointed out by arrows in the BSI map in FIG. 16c and as classification pixels in FIG. 17.

The BSI map of FIG. 16c has notably more information content than the MCI map in FIG. 16a. The pixels on the periphery have the highest magnitude in the proliferating shell, with low (dark) response internal to the tumor. The BSI response is due specifically the drug response and not simply a reflection of motility. Therefore, the enhanced pixels in the proliferating shell show that the drug is either not penetrating the tumor (even though the drug is a small molecule drug that has good penetration) or else the quiescent cells in the core are not responding to the drug treatment.

More striking is the small cluster of pixels in the lower right hand corner. These pixels show a very different spectral response to the drug compared to the periphery areas. This pathological response to the drug is likely due to a genetic mutation during the growth of the tumor to a genotype and phenotype that responds differently to this Raf inhibitor. Such mutations are a major factor in the resistance of tumors to anti-cancer drugs and are often related to the 3D microenvironment that is missed in conventional 2D cell culture screens. Therefore, the BSI techniques disclosed herein have the potential to screen for heterogeneous tumor response to anti-cancer drugs to find phenotypic signatures that would indicate that the patient would not have an overall positive response to therapy.

The BSI image of FIG. 16c and the classification map of FIG. 17 demonstrate a lack of homogeneity of the response to the anti-cancer drug. Thus, while an MCI analysis might reveal that the specimen did respond to the drug based on the high-frequency response at the upper left portion of the image in FIGS. 16c, 17, the use of biodynamics specroscopic imaging clarifies that this same response is not carried throughout the specimen. To the contrary, the majority of the specimen is unaffected or only slightly affected by the treatment, as evidenced by the dark area spanning the majority of the image in FIGS. 16c, 17.

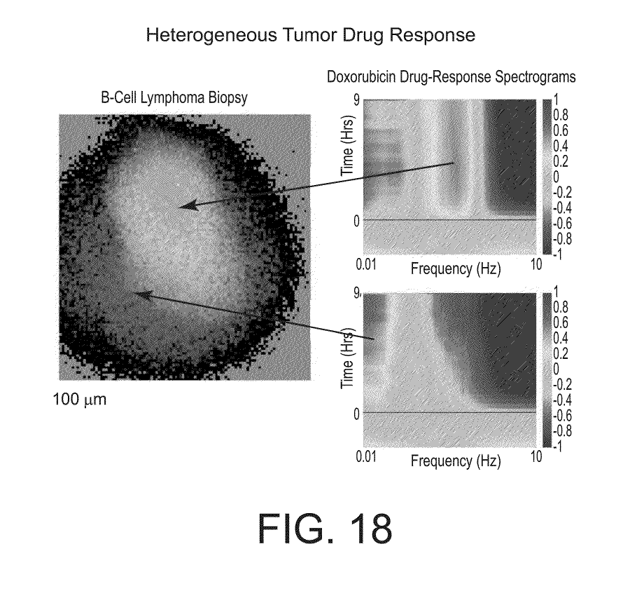

An additional example of BSI is shown in FIG. 18 for an ex vivo biopsy sample of canine multicentric B-cell lymphoma. The BSI image is on the left, showing a two-color pixel map of two very different spectral responses that are shown on the right in selected spectrograms. One spectral signature displayed mid-frequency enhancement and suppression at both low and high frequencies. This signature is coded in green in the BSI image. The other spectral signature had low-frequency enhancement and high-frequency suppression, which is coded as red in the BSI image. This example shows the importance of BSI to capture what is known as “tumor heterogeneity”. This ex vivo biopsy is responding to the anticancer drug doxorubicin. The different tissue responses to a single drug can have important ramifications for cancer treatment if part of a tumor responds, but a different part of the tumor does not.

Those skilled in the art will recognize that numerous modifications can be made to the specific implementations described above. The implementations should not be limited to the particular limitations described and described in the claims provided below. Other implementations may be possible.

### APPENDIX

### References

[1] S. C. W. Hyde, R. Jones, N. P. Barry, l. C. Dainty, P. M. W. French, K. M. Kwolek, D. D. Nolte, and M. R. Melloch, “Depth-resolved holography through turbid media using photorefraction,” IEEE Journal of Selected Topics in Quantum Electronics, vol. 2, pp. 965-975, December 1996.
[2] P. Yu, M. Mustata, l. l. Turek, P. M. W. French, M. R. Melloch, and D. D. Nolte, “Holographic optical coherence imaging of tumor spheroids,” Applied Physics Letters, vol. 83, pp. 575-577, Jul. 21, 2003.
[3] M. Laubscher, M. Ducros, B. Karamata, T. Lasser, and R. Salathe, “Video-rate three dimensional optical coherence tomography,” Optics Express, vol. 10, pp. 429-435, May 6, 2002.
[4] A. Dubois, K. Grieve, G. Moneron, R. Lecaque, L. Vabre, and C. Boccara, “Ultrahigh resolution full-field optical coherence tomography,” Applied Optics, vol. 43, pp. 2874-2883, May 10, 2004.
[5] B. Karamata, M. Leutenegger, M. Laubscher, S. Bourquin, T. Lasser, and P. Lambelet, “Multiple scattering in optical coherence tomography. II. Experimental and theoretical investigation of cross talk in wide-field optical coherence tomography,” Journal of the Optical Society of America a-Optics Image Science and Vision, vol. 22, pp. 1380-1388, July 2005.
[6] S. C. W. Hyde, N. P. Barry, R. Jones, l. C. Dainty, and P. M. W. French, “Sub-100 Micron Depth-Resolved Holographic Imaging Through Scattering Media in the Near Infrared,” Optics Letters, vol. 20, pp. 2330-2332, 1995.
[7] D. D. Nolte, “Semi-insulating semiconductor heterostructures: Optoelectronic properties and applications,” J. Appl. Phys., vol. 85, pp. 6259-6289, 1999.
[8] I. Yamaguchi and T. Zhang, “Phase-shifting digital holography,” Optics Letters, vol. 22, pp. 1268-1270, Aug. 15, 1997.
[9] E. Cuche, F. Bevilacqua, and C. Depeursinge, “Digital holography for quantitative phase contrast imaging,” Optics Letters, vol. 24, pp. 291-293, Mar. 1, 1999.
[10] F. Dubois, L. Joannes, and l. C. Legros, “Improved three-dimensional imaging with a digital holography microscope with a source of partial spatial coherence,” Applied Optics, vol. 38, pp. 7085-7094, Dec. 1, 1999.
[11] T. C. Poon, T. Yatagai, and W. Juptner, “Digital holography—coherent optics of the 21^{st} century: introduction,” Applied Optics, vol. 45, pp. 821-821, Feb. 10, 2006.
[12] K. Jeong, J. J. Turek, and D. D. Nolte, “Fourier-Domain Digital Holographic Optical Coherence Imaging of Living Tissue,” Appl. Opt., vol. 46, pp. 4999-5008, 2007.
[13] P. Yu, L. Peng, M. Mustata, J. 1. Turek, M. R. Melloch, and D. D. Nolte, “Time Dependent Speckle in Holographic Optical Coherence Imaging and the State of Health of Tumor Tissue,” Optics Letters, vol. 29, pp. 68-70, 2004.
[14] K. Jeong, l. l. Turek, and D. D. Nolte, “Imaging Motility Contrast in Digital Holography of Tissue Response to Cytoskeletal Anti-cancer Drugs,” Optics Express, vol. 15, pp. 14057-14064, 2007.
[15] D. D. Nolte, “Patent Application 20130144151 System and Method for Determining Modified States of Health of Living Tissue,” 2013.
[16] D. D. Nolte, “Patent Application 20130096017 Digital Holographic Method of Measuring Cellular Activity and of Using Results to Screen Compounds,” 2013.
[17] D. D. Nolte, “Patent Application 20130088568 Digital Holographic Method of Measuring Cellular Activity and Measuring Apparatus with Improved Stability,” 2013.
[18] D. D. Nolte, “Patent Application 20100331672 Method and Apparatus for Motility Contrast Imaging,” 2010.
[19] R. An, 1. Turek, D. E. Matei, and D. Nolte, “Live tissue viability and chemosensitivity assays using digital holographic motility contrast imaging,” Applied Optics, vol. 52, pp. A300-A309, January 2013.
[20] D. D. Nolte, R. An, J. 1. Turek, and K. Jeong, “Tissue dynamics spectroscopy for phenotypic profiling of drug effects in three-dimensional culture,” Biomed. Opt. Express, vol. 3, pp. 2825-2841, 2012.
[21] D. D. Nolte, R. An, l. Turek, and K. Jeong, “Holographic tissue dynamics spectroscopy,” Journal of Biomedical Optics, vol. 16, pp. 087004-13, August 2011.
[22] D. D. Nolte, R. An, 1. Turek, and K. Jeong, “Tissue Dynamics Spectroscopy for Three Dimensional Tissue-Based Drug Screening,” Jala, vol. 16, pp. 431-442, December 2011.
[23] M. Suissa, C. Place, E. Goillot, and E. Freyssingeas, “Internal dynamics of a living cell nucleus investigated by dynamic light scattering,” European Physical Journal E, vol. 26, pp. 435-448, August 2008.
[24] X. L. Nan, P. A. Sims, and X. S. Xie, “Organelle tracking in a living cell with microsecond time resolution and nanometer spatial precision,” Chemphyschem, vol. 9, pp. 707-712, Apr. 4, 2008.
[25] K. 1. Karnaky, L. T. Garretson, and R. G. Oneil, “Video-Enhanced Microscopy of Organelle Movement in an Intact Epithelium,” Journal of Morphology, vol. 213, pp. 21-31, July 1992.
[26] N. A. Brazhe, A. R. Brazhe, A. N. Pavlov, L. A. Erokhova, A. I. Yusipovich, G. V. Maksimov, E. Mosekilde, and 0. V. Sosnovtseva, “Unraveling cell processes: Interference imaging interwoven with data analysis,” Journal of Biological Physics, vol. 32, pp. 191-208, October 2006.
[27] B. Trinczek, A. Ebneth, and E. Mandelkow, “Tau regulates the attachment/detachment but not the speed of motors in microtubule-dependent transport of single vesicles and organelles,” Journal of Cell Science, vol. 112, pp. 2355-2367, July 1999.
[28] F. Brochard and l. F. Lennon, “Frequency Spectrum of Flicker Phenomenon in Erythrocytes,” Journal De Physique, vol. 36, pp. 1035-1047, 1975.
[29] H. Strey and M. Peterson, “Measurement of Erythrocyte-Membrane Elasticity by Flicker Eigenmode Decomposition,” Biophysical Journal, vol. 69, pp. 478-488, August 1995.
[30] A. Zilker, M. Ziegler, and E. Sackmann, “Spectral-Analysis of Erythrocyte Flickering in the 0.3-4-Mu-M-1 Regime by Microinterferometry Combined with Fast ImageProcessing,” Physical Review A, vol. 46, pp. 7998-8002, Dec. 15, 1992.
[31] M. A. Peterson, H. Strey, and E. Sackmann, “Theoretical and Phase-Contrast Microscopic Eigenmode Analysis of Erythrocyte Flicker—Amplitudes,” Journal De Physique Ii, vol. 2, pp. 1273-1285, May 1992.
[32] Y. Z. Yoon, H. Hong, A. Brown, D. C. Kim, D. 1. Kang, V. L. Lew, and P. Cicuta, “Flickering Analysis of Erythrocyte Mechanical Properties: Dependence on Oxygenation Level, Cell Shape, and Hydration Level,” Biophysical Journal, vol. 97, pp. 1606-1615, Sep. 16, 2009.
[33] J. Evans, W. Gratzer, N. Mohandas, K. Parker, and 1. Sleep, “Fluctuations of the red blood cell membrane: Relation to mechanical properties and lack of ATP dependence,” Biophysical Journal, vol. 94, pp. 4134-4144, May 15, 2008.
[34] R. An, K. Jeong, J. Turek, and D. Nolte, Label-free Mitosis Detection in Tumor Spheroids using Tissue Dynamics Imaging, in Dynamics and Fluctuations in Biomedical Photonics VII, vol. 8222, V. V. Tuchin Ed., ed, 2012.
[35] R. An, K. Jeong, J. Turek, and D. Nolte, Identifying Mitosis Deep in Tissue using Dynamic Light Scattering Fluctuation Spectroscopy, in Biomedical Applications of Light Scattering VI. vol. 8230, A. P. Wax and V. Backman, Eds., ed, 2012.

What is claimed is:

1. A method for evaluating the effect of an external perturbation on the health of a living biological specimen comprising:
obtaining a holographic three-dimensional image of the biological specimen over time and subject to the external perturbation;
constructing the fluctuation power spectrum for each pixel in the three-dimensional image;
using the fluctuation power spectrum, generating a normalized spectrum relative to a baseline spectrum acquired before the perturbation is applied for each pixel of dynamic intensity as a function of frequency for multiple time points after the perturbation is applied to produce a plurality of normalized relative spectra for each pixel;
selecting a frequency range from among characteristic frequencies corresponding to dynamic activity of naturally occurring biological events within the specimen;
filtering the normalized relative spectra for each pixel according to the selected frequency range to provide data corresponding only to the dynamic activity associated with the selected frequency range; and
comparing the normalized relative spectra over time to evaluate the effect of the external perturbation on the dynamic activity.

2. The method of claim 1, wherein the dynamic activity is cell mitosis.

3. The method of claim 1, wherein:
the step of generating a normalized spectrum includes;
defining a voxel as 2×2 pixels; and
generating the normalized relative spectra for each voxel; and
the step of filtering the normalized relative spectra includes filtering the normalized relative spectra for each voxel.

4. The method of claim 1, wherein:
the step of obtaining a holographic three-dimensional image includes obtaining a data set at discrete time intervals;
and the step of generating a normalized spectrum includes averaging the fluctuation power spectrum over two or more discrete time intervals to produce a modified spectra that is used in generating the normalized spectrum.

5. The method of claim 4, wherein the discrete time intervals are four minutes and the modified spectra includes the data sets for five discrete time intervals.

6. The method of claim 1, wherein the step of generating a normalized spectrum includes:
generating a baseline fluctuation power spectrum of each pixel prior to application of the external perturbation; and
for each fluctuation power spectrum obtained at subsequent times, generating a normalized power spectrum for each pixel by normalizing the fluctuation power spectrum to the baseline fluctuation power spectrum.

7. The method of claim 6 wherein the baseline used to generate the normalized power spectrum for each pixel is the average of all spectra over all pixels and all times.

8. The method of claim 6 wherein the baseline used to generate normalized power spectrum for each pixel is the average of all spectra over all pixels for all times before the application of the perturbation.

9. The method of claim 6, wherein the baseline is the average of all spectra for a specific pixel over all times before the application of the perturbation, wherein these data are subsequently used to fit to a smooth fitted function which is used to perform the baseline subtraction and normalization of the normalized power spectrum for each pixel.

10. The method of claim 1, wherein the external perturbation is the application of a drug.

11. The method of claim 1, wherein:
the step of selecting a frequency range includes selecting a second frequency range corresponding to a second biological activity related to the first selected biological activity; and
the step of filtering the spectrogram for each pixel includes;
evaluating the dynamic spectra for the pixel at a first time interval;
if the dynamic spectra at the first interval exceeds a threshold indicative of the occurrence of the biological activity, then filtering the spectrogram at an immediately subsequent time interval according to the second frequency range; and
if the dynamic spectra at the immediately subsequent time interval exceeds a threshold indicative of the occurrence of the second biological activity, then identifying the pixel as having the first selected biological activity.

12. A method for evaluating the effect of an external perturbation on the health of a living biological specimen comprising:
obtaining a holographic three-dimensional image of the biological specimen over time and subject to the external perturbation;
constructing a fluctuation power spectrum for each pixel in the three-dimensional image;
using the fluctuation power spectrum, generating a time-frequency spectrogram for each pixel of dynamic intensity as a function of frequency and time;
selecting time-frequency mask patterns corresponding to dynamic activity of naturally occurring biological processes that change with time within the specimen;
filtering the spectrogram for each pixel according to the selected time-frequency masks to provide data corresponding only to the dynamic activity associated with the selected time-frequency mask to evaluate the effect of the external perturbation on the dynamic activity.

13. The method of claim 12 wherein the data are represented on a pixel or voxel basis in a 2D sectional image of the specimen.

14. The method of claim 12 wherein the data are represented on a voxel basis in a 3D volumetric rendering of the specimen.
